(19) United States
(12) Patent Application Publication
(10) Pub. No.: US 2006/0164212 A1
(43) Pub. Date: Jul. 27, 2006

(54) Method for identifying a plurality of transponders located in a space by a reader having several antennae

(75) Inventors: Thierry Roz, Hauts-Geneveys (CH); Maksimilijan Stiglic, Maribor (SI)

Correspondence Address: GRIFFIN & SZIPL, PC, SUITE PH-1, 2300 NINTH STREET, SOUTH, ARLINGTON, VA, 22204, US

(73) Assignee: EM Microelectronic-Marin SA, Marin (CH)

(21) Appl. No.: 10/530,201

(22) PCT Filed: Sep. 26, 2003
(86) PCT No.: PCT/EP03/10743

§ 371 Date: Apr. 4, 2005

(30) Foreign Application Priority Data
Oct. 2, 2002 (EP) 02079135.6

(51) Int. Cl. H04Q 5/22

(52) U.S. Cl. 340/10.2; 340/10.1; 340/572.1; 340/572.7; 340/10.34

(57) ABSTRACT

The invention concerns a method for identifying a plurality of passive transponders 6 using a reader comprising several antennae whose detection fields do not merge spatially and/or temporally, said transponders comprising an analogue 34 or digital 52 memory for storing binary information for a certain time interval in the absence of any reader feeding fields. For each antenna, the method sequentially implements an anti-collision protocol during which each identified transponder is set in a “silent” mode. The method provides for this information to be stored in said memory of each transponder for a time interval including at least the switching period between a first antenna and a second antenna of the reader. This prevents detection of the same transponders by several antennae, which makes the identification method quicker and more efficient.

The present invention concerns a method for identifying a plurality of passive transponders located in a detection space by a reader having several antennae whose transmission-reception fields are not merged spatially or temporally.

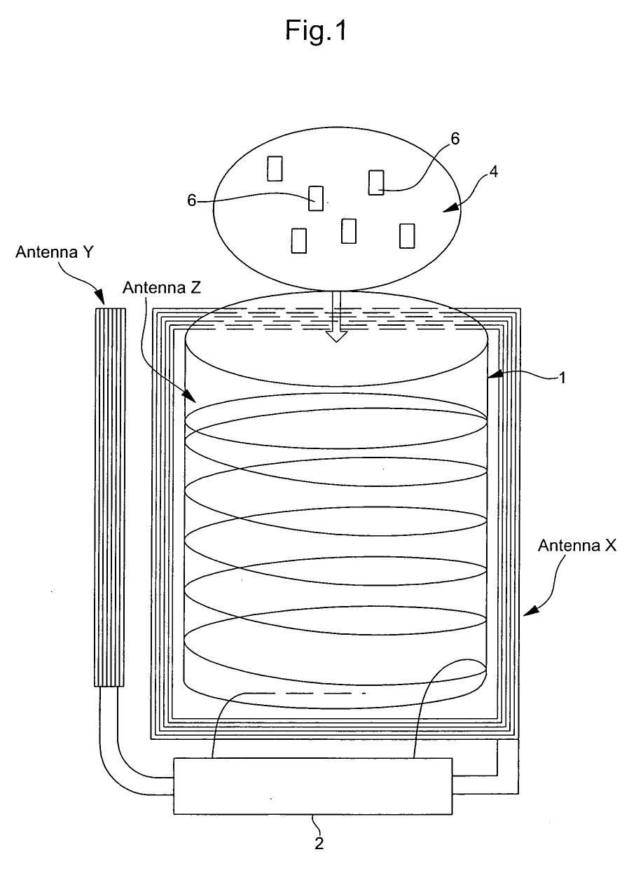

In particular, the invention concerns a method for identifying and drawing up the list of a set of transponders associated with various objects placed in a defined space, for the purpose of establishing an inventory of such objects. By way of example, the method concerns the management of the entry or exit of batches of clothing respectively associated with transponders. These clothes are brought in bulk in bags and placed in a cylinder defining a detection space of the reader. This application is shown in FIG. 1 which shows a reader 2 comprising three antennae X, Y and Z having different orientations with their transmission-reception fields that do not merge spatially. Antenna Z is arranged around a cylinder 1 for receiving the objects to be identified. These objects form a set or a batch 4, each of them being associated with a transponder 6.

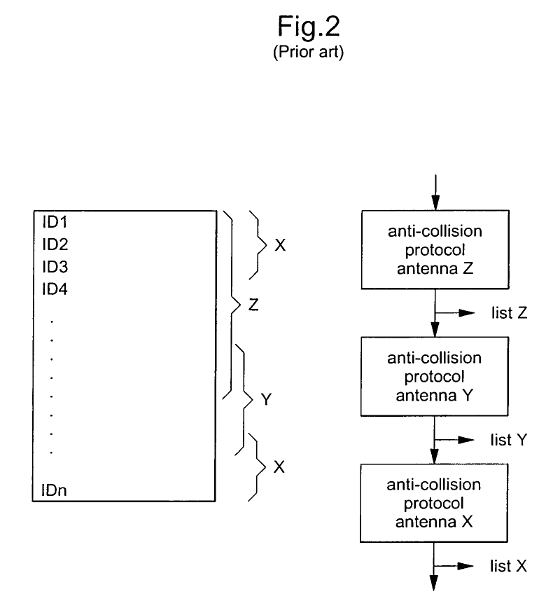

FIG. 2 shows schematically the method for identifying the plurality of transponders in accordance with the known prior art. An anti-collision protocol is provided for each antenna one after the other. Thus, the method starts an anti-collision protocol by activating antenna Z, which enables list Z to be established from a sub-set of the plurality of objects to be identified. In a conventional manner, in such an anti-collision protocol, when a transponder is identified, it is set into a “silent” mode so that it no longer sends a response signal during successive interrogations after it has been detected.

Given that the transmission-reception field of antenna Z is two-directional, only a part of the transponders having a favourable communication orientation with antenna Z can be detected by the latter. At the end of the anti-collision protocol associated with antenna Z, the identification method activates another antenna Y having a different orientation. An anti-collision protocol is also implemented with this antenna Y for establishing a list Y forming a sub-set of the plurality of transponders. However, as is shown in FIG. 2, some transponders are identified by antenna Z and also by antenna Y. Likewise, during the anti-collision protocol with antenna X, a sub-set of list X is formed of transponders that have already been identified by the other antennae. In this FIG. 2, the plurality of transponders is referenced ID1 to IDn.

Thus, the complete identification method of the plurality of transponders last for a relatively long time, which is due in particular to the fact that some transponders can pick up the transmission field of at least two antennae and communicate with the latter. This situation results from the fact that the transponders used in this type of application maintain the “silent” mode while they are being powered. However, as soon as there is an interruption to the power supply, the transponders are automatically re-initialised and lose their respective state. Such an interruption to the power supply occurs during the identification method when passing from one antenna to another. In fact, for a certain period of time, the first antenna is deactivated and a switch occurs in favour of the second antenna. During this operation of switching antennae and activating the new selected antenna, the passive transponders are no longer powered. Consequently, the transponders already identified by an antenna can be identified again by another antenna. The redundancy in transponder detection thus increases the duration of the identification method, and the final sorting step necessary for establishing a complete list of the identified transponders, avoiding doubles or even triples.

It is an object of the present invention to overcome the aforementioned major drawback by proposing an efficient identification method with a reduced detection time.

Thus, the identification method according to the invention is characterized in that there is provided in each transponder a memory arranged for keeping its data with power only for a certain period of time, and in that data is stored in this memory concerning the identification of the transponder concerned, in particular activation of the “silent” mode, at least at the end of implementation of the anti-collision protocol associated with a first antenna, this data being kept by the transponders identified by this first antenna for at least an interval of time comprising the first switching period of this first antenna to said second antenna during which there is no feeding field for the passive transponders.

Owing to these features, the second antenna is prevented from detecting the same transponders already identified by the first antenna. Doubles are thus removed from the common list of transponders identified by the two antennae.

It will also be noted that the memory provided here does not require the use of a method peculiar to the non-volatile memories for manufacturing the transponder.

In a preferred implementation, the memory is an analogue memory formed by a capacitor associated with a switch for loading it and to means for detecting the voltage level of the capacitor to provide binary data to the transponder's logic circuit.

The invention will be explained hereinafter in more detail with reference to the drawing, given by way of non-limiting example and in which:

FIG. 1, already described, shows schematically an installation for implementing the identification method according to the invention;

FIG. 2, already described, shows a method for identifying a plurality of transponders in accordance with the prior art;

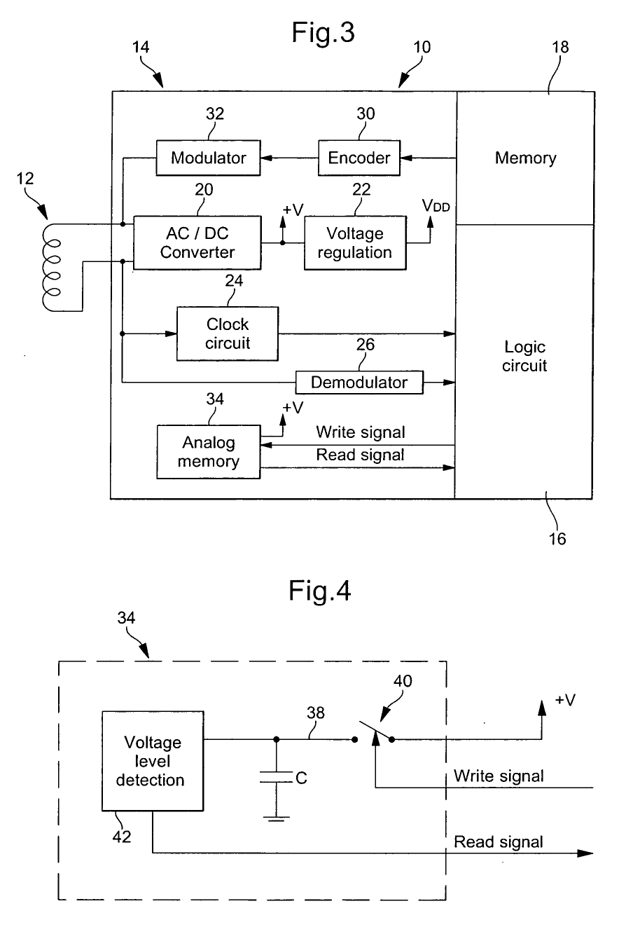

FIG. 3 shows schematically the arrangement of a transponder for implementing the identification method according to the invention;

FIG. 4 shows a variant of an analogue memory of the transponder of FIG. 3;

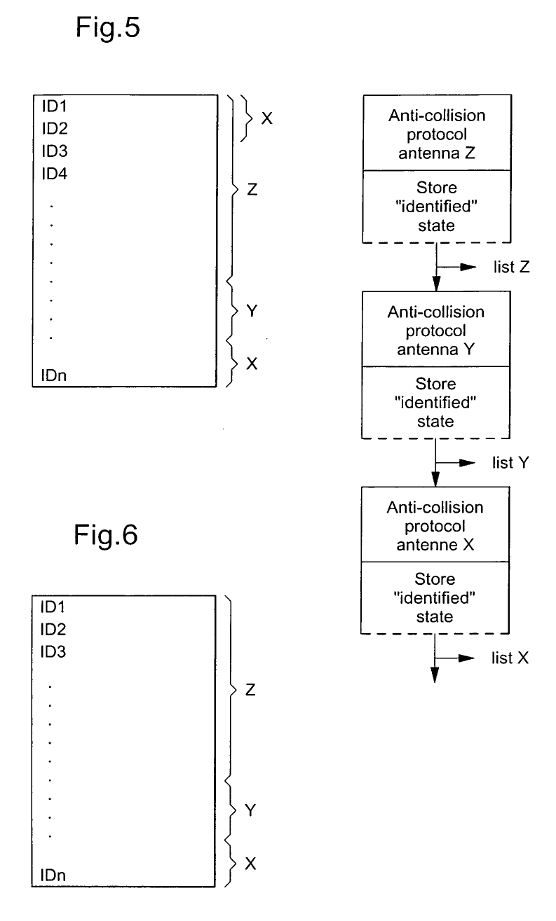

FIG. 5 schematically describes a preferred implementation of the identification method according to the invention, and

FIG. 6 shows a list of the plurality of transponders and the sub-sets detected by three antennae X, Y and Z according to a variant of the method.

In FIG. 3, transponder 6 according to the invention includes an antenna 12 connected to an analogue part 14. The electronic circuit 10 of the transponder also includes a logic circuit 16 and a memory 18. In a conventional manner, the analogue part includes an AC/DC converter 20 connected to both ends of the antenna coil. A rectified voltage +V is obtained at the output of converter 20. This voltage signal is supplied to regulating means 22 which produce voltage V_{DD} used for powering the various parts of electronic circuit 10.

A clock signal is obtained by the clock circuit 24 which extracts a time base from the received signal carrier. Then, a demodulator 26 used for decoding the received data is also provided. Transponder 6 is also arranged for providing at least one response signal using a coder 30 and a modulator 32 whose output is connected to antenna 12.

According to the invention, in each memory there is preferably provided an analogue memory 34 powered directly by voltage +V at the output of converter 20. The arrangement of this analogue memory is shown in FIG. 4. It comprises a capacitor C having one terminal at earth and the other connected to an electrical path 38 along which there is arranged a switch 40 that can be activated by logic circuit 16. Switch 40 is connected to potential +V so that capacitor C can be loaded to a maximum when switch 40 is conducting, i.e. closed. Analogue memory 34 also includes means 42 for detecting the voltage level of capacitor V. These detection means 42 are formed of a comparator to one input of which a reference voltage is provided. At the output, the analogue memory supplies a binary read signal depending upon whether the capacitor voltage is above or below the reference voltage.

In a first variant, the capacitor is integrated in the electronic circuit of the transponder formed entirely of an integrated circuit. In this case, for a capacitor of reduced dimensions and thus of a relatively low cost, it is possible to keep the high voltage data, i.e. above the reference voltage, for a period of the order of a second in the absence of powering by the reader field. By increasing the dimensions of the integrated capacitor, it is possible to be able to keep this data for around ten seconds.

The write signal provided by the logic circuit thus enables switch 40 to be activated to load capacitor C when the passive transponder is powered by the external field.

The analogue memory thus forms a “semi-volatile” memory, the length of time that data is preserved in this memory in the absence of a feed field depending particularly upon its dimensions. In order to increase this period of time, another variant provides for the arrangement of the capacitor in the form of a discrete element connected to electronic circuit 10 of the transponder. This particularly onerous and less compact solution than the integrated solution enables the data to be kept in analogue memory 34 for a period of the order of a minute particularly around ten minutes. This variant enables a particular implementation of the method according to invention to be implemented, as will be explained hereinafter.

Other types of memory having a “semi-volatile” character of the type described hereinbefore can evidently be provided without departing from the scope of the present invention.

With reference to FIG. 5, a preferred implementation of the identification method according to the invention will be described hereinafter. As in the prior art mentioned in FIG. 2, a plurality of transponders are identified in a given detection space using several antennae by sequentially implementing an anti-collision protocol for each of the antennae. This anti-collision protocol provides for any transponder detected by a given antenna during the anti-collision protocol associated with such antenna, to be set in a “silent” mode. In order to overcome the major drawback of the prior art, at the end of the anti-collision protocol with a first antenna Z, a command is sent by the reader to the transponders that were able to be detected by antenna Z instructing said transponders to place the data concerning their state in analogue memory 34, i.e. if they have been identified and set in “silent” mode. Logic circuit 16 of the transponder thus sends a write signal to memory 34 while the transponders are still being powered by the field of antenna Z, so that the identified transponders set in “silent” mode load their capacitor C, which then has a high voltage. Thus, the sub-set of transponders forming list Z will keep the data because they were identified by antenna Z at least during a certain time interval after deactivation of antenna Z. Analogue memory 34 is arranged such that this time interval comprises at least the switching period from antenna Z to the next antenna Y. When this antenna Y is activated, the transponder again receive a feed field and the analogue memory, in a preferred first variant, automatically supplies logic circuit 16 with the binary data relating to the voltage of capacitor C. If capacitor C has been loaded at the end of the anti-collision protocol associated with antenna Z, the logic circuit receives the data that the transponder concerned has already been identified during the preceding protocol. Thus, the logic circuit again sets transponder 6 into the “silent” mode such that this transponder will not longer respond to the interrogation signals from the reader during the anti-collision protocol associated with antenna Y. Consequently, as shown in FIG. 5, the sub-set of identified transponders forming list Y is totally distinct from the sub-set forming list Z. As a result, the anti-collision protocol associated with antenna Y is quicker than in the case of the prior art. Moreover, a final sorting step to remove any doubles becomes superfluous or at least quicker if implemented in any event for reasons of reliability of the identification method.

The identification method described with reference to FIG. 5 concerns a system in which the transponders have an integrated analogue memory so as to retain binary data for a time interval slightly greater than the switching period between the successive activation of two antennae by the reader.

At the end of the anti-collision protocol associated with antenna Y, the reader sends a control signal so that the identified transponders retain this information. Then, the reader switches between antenna Y and antenna X to execute a third anti-collision protocol associated with antenna X. Owing to the method of the invention, list X of the sub-set of transponders identified by antenna X does not overlap with the sub-set of list X. However, in this variant of the method, list X can have some overlap with list Z, as shown in FIG. 5. This arises from the fact that some transponders activated by antenna Z have no longer been activated by antenna Y. Since the anti-collision protocol associated with antenna Y has had a longer period than said time interval for preserving data in integrated memory 34, when these transponders are activated again by antenna X from which they receive the feed field, the information that they were previously identified by antenna Z has not been able to be preserved.

In order to overcome this remaining drawback of the variant of the method of the invention described hereinbefore, it is possible, as previously mentioned, to provide a relatively large capacitor C, particularly by means of a discrete element connected to the electronic circuit, to keep the information from a higher voltage than the reference voltage in memory 34 during an interval of time encompassing the period necessary for the anti-collision protocol associated with antenna Y. Depending upon the number of transponders to be identified, which can be several hundred, the anti-collision protocol associated with antenna Y can last from a period of the order of a minute to around ten minutes. In this variant, it is possible to obtain three sub-sets of transponders, respectively forming lists X, Y and Z, with no overlap. The inventory of the plurality of transponders placed in the reader's detection field is thus formed by these three lists without any doubles, as is shown schematically in FIG. 6.

In another variant of the method, the information relating to the state of the “semi-volatile” memory is communicated to the logic circuit upon interrogation of the latter. Other variants can be envisaged by those skilled in the art.

In another embodiment of the invention, shown in FIG. 7, the state relating to identification of the transponder is temporarily stored in a digital memory formed by a latch, such variant being given in a non-limiting manner. Those elements that have already been described previously will not be described again here in detail. In a conventional manner, regulating circuit 22 is associated with a power-on-reset (POR) circuit acting on logic circuit 16. This POR circuit initialises logic circuit 16 when the supply voltage goes below a given threshold. According to the invention, a latch 52 is provided, connected to the logic circuit but arranged so that the POR circuit does not initialise it when the power supply is interrupted. However, this POR circuit activates a switch arranged between supply VDD and a supply terminal of the latch when the transponder supply voltage falls below said given threshold. This terminal is connected to a latch supply capacitor 54. In other words, capacitor 54 and the latch are arranged in parallel and together form an independent unit, electrically insulated from the rest of the transponder's electronic circuit during an interruption to the power supply, i.e. when the latter becomes lower than said threshold.

As in the first embodiment described hereinbefore, the latch receives at input a signal 56 concerning the transponder's state of identification and supplies when read a logic signal given by the state of the latch corresponding to this state of identification. Such reading is automatic when the logic circuit is switched on or when the latter is interrogated.

Then, latch 52 can be initialised via a control signal 60 acting on the latch, particularly at the start of an identification protocol.

It will be noted that the write signal can act automatically and directly on the latch when the state of identification of the transponder is changed, i.e. just after identification. In this variant, it is thus no longer necessary to send, at the end of the identification protocol relating to a given antenna, a write signal as to the state of identification of the transponder. In this embodiment, latch 52 keeps its logic state for a certain limited period, depending upon the capacitor 54 selected and the implementation thereof. In fact, the leakage currents inherent in the electronic circuits generate a decrease in the electrical charge and the voltage of capacitor 54. It will be noted that these leakage currents can be of variable quantities. It is thus possible to define their size in the design of the transponder's electronic circuit.

Finally, it will be noted that the present invention also applies in the same manner in the case of several antennae having the same orientation, but activated in succession, particularly when these antennae are multiplexed. In such case, according to the present terminology, the transmission-reception fields of the antennae are not merged temporally. Moreover, they can also not be merged spatially, particularly when some distance separates them.

1-7. (canceled)

8. A method for identifying a plurality of passive transponders located in a detection space of a reader having at least a first antenna (Z) and a second antenna (Y) whose respective transmission-reception fields are not merged spatially and/or temporally, said method implementing an anti-collision protocol for each of the antennae during which each transponder identified by a given antenna is then set in a “silent” mode during the protocol associated with said antenna, wherein in each transponder there is provided a memory arranged to keep its information without the reader field being powered only for a certain period of time, and wherein information is stored in said memory concerning the state of identification of the transponder concerned, in particular the fact of activating the “silent” mode, at least at the end of the anti-collision protocol associated with said first antenna, said information being kept by at least the transponders identified by said first antenna at least for an interval of time including the period of switching from the first antenna to said second antenna during which there is no supply field for the transponders.

9. The identification method according to claim 8, wherein said memory is an analogue memory arranged to be able to keep binary information, said interval of time being of the order of ten seconds.

10. The identification method according to claim 9, wherein said analogue memory is formed by a capacitor integrated in the analogue part of the electronic circuit of the transponder.

11. The identification method according to claim 8, wherein said memory is an analogue memory, said interval of time being of the order of a minute to ten minutes.

12. The identification method according to claim 11, wherein said analogue memory includes a capacitor formed by a discrete element electrically connected to the analogue part of the electronic circuit of the transponder.

13. The identification method according to claim 8, wherein each of the transponders includes a logic circuit and a power-on-reset circuit (POR) for said logic circuit and wherein said memory is a digital memory, the latter being arranged in parallel with a capacitor such that, when the supply voltage of the transponder becomes lower than a given threshold, said power-on-reset circuit does not reset said logic memory but commands a switch to electrically insulate said logic memory and said loaded capacitor.

14. The method according to claim 13, wherein, at input, said logic memory can receive a control signal provided by said logic circuit to initialise said logic memory selectively.
